(19) United States
(12) Patent Application Publication
(10) Pub. No.: US 2026/0140952 A1
(43) Pub. Date: May 21, 2026

(54) CONTEXT-BASED FOLLOW UP QUERY GENERATION IN TEXT-TO-DATABASE QUERY CONVERSION SYSTEMS

(71) Applicant: Palo Alto Networks, Inc., Santa Clara, CA (US)

(72) Inventors: Sheng Yang, Santa Clara, CA (US); William Redington Hewlett, II, Mountain View, CA (US)

(21) Appl. No.: 18/940,529

(22) Filed: Nov. 7, 2024

(51) Int. Cl. G06F 16/2455; G06F 16/242; G06F 16/248

(52) U.S. Cl. CPC G06F 16/24553; G06F 16/243; G06F 16/248

(57) ABSTRACT

Follow ups to user queries are generated in text-to-database query conversion services based on context provided by generated database queries and/or database query execution results. A query generation service extracts an entity type(s) from a database query generated from a user query and, if applicable, from the execution results. The query generation service retrieves a user query template(s) and corresponding database query template(s) for a same table of a target database as the database query and have parameters of the same types as the extracted entity type(s). The query generation service populates the parameter(s) of each user query template and database query template with an entity name(s) that correspond to the entity type(s) and were extracted from the database query and/or database query execution result. The populated user query templates are provided in response to the user query as follow up queries.

### BACKGROUND

The disclosure generally relates to data processing (e.g., CPC subclass G06F) and to computing arrangements based on specific computational models (e.g., CPC subclass G06N).

The Stanford Institute for Human-Centered Artificial Intelligence created an interdisciplinary initiative named the Center for Research on Foundation Models. They coined the term “foundation models” to refer to machine learning models “trained on broad data at scale such that they can be adapted to a wide range of downstream tasks.” Some models considered foundation models include BERT, GPT-4, Codex, and LLaMA. Foundation models are based on artificial neural networks including generative adversarial networks (GANs), transformers, and variational encoders.

Multiple applications of foundation models in the field of natural language processing, particularly in the case of language models such as large language models (LLMs), have been realized. One such application is the use of language models for text-to-Structured Query Language (SQL) conversion. Text-to-SQL conversion refers to generating SQL queries representative of natural language text indicated in prompts. Language models used for text-to-SQL conversion can be pre-trained models adapted for this task with various techniques, such as prompt tuning, fine-tuning, or with one-or few-shot prompting using prompts engineered for the task of generating database queries from natural language text.

### BRIEF DESCRIPTION OF THE DRAWINGS

Embodiments of the disclosure may be better understood by referencing the accompanying drawings.

FIG. 1 is a conceptual diagram of an overview of generating follow up queries as part of fulfilling user queries with text-to-database query conversion.

FIG. 2 is a conceptual diagram of extracting entity types and names from a database query and results of executing the database query against a target database.

FIG. 3 is a flowchart of example operations for generating follow up queries in response to received user queries.

FIG. 4 is a flowchart of example operations for generating follow up queries based on a database query that has been generated from a user query.

FIG. 5 is a flowchart of example operations for generating follow up queries based on a database query generated from a user query and a result of executing the database query.

FIG. 6 is a flowchart of example operations for retrieving generic follow up queries to a user query.

FIG. 7 is a flowchart of example operations for generating user query templates based on example pairs of user queries and database queries that have previously been created.

FIG. 8 depicts an example computer system with a follow up query generation service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

A “prompt” refers to input to a foundation model, and prompting refers to the act of submitting a prompt to a model to perform inference based on the submitted prompt. A prompt at least includes a task for the model and one or more instructions for the task in natural language. A prompt can also include context, constraints, and examples. In other words, a prompt is a natural language task instruction(s) and other information that can assist the model in performing the task successfully. A prompt can have more than one task instruction and prompts can be chained to incorporate responses from the model into a subsequent prompt. A prompt can be entered by a user and/or constructed from a prompt template.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Disclosed herein are techniques for generating follow up queries in text-to-database query conversion services. While conventional recommendation systems recommend pre-existing content (e.g., videos) to users, such as based on scoring and ranking candidates from existing content, the disclosed follow up query generation service (“the query generation service” for simplicity) generates follow up queries to queries submitted by users based on context provided by the corresponding database query representations thereof. A user query is converted to a database query by a foundation model and executed against a target database to yield query results. The query generation service extracts one or more types of entities from the database query and, if applicable, from the execution results. The query generation service retrieves one or more user query templates and associated database query templates that correspond to the same table of the target database as the database query and have parameters that correspond to the extracted entity type(s). A plurality of user query templates and corresponding database query templates were previously created based on pairs of user queries and their corresponding database queries. Each user query template and database query template is parameterized such that each parameter corresponds to a type of entity that can be extracted from a database query (e.g., a database field name). The query generation service populates the parameter(s) of each user query template and database query template with one or more respective entity names extracted from the database query (and from the database query execution result, if any entity names were extracted therefrom). The populated user query templates are provided in a response to the user query as follow up queries that a user can select as a follow up to their initial query. Since the database queries corresponding to the follow up queries have already been created based on population of the database query templates with extracted entity names, if one of the follow up queries is selected, the query generation service can execute the respective database query against the target database without again invoking the foundation model to generate a database query representing the follow up query. This reduces latencies and costs associated with generating database queries representing user queries via prompting foundation models.

### Example Illustrations

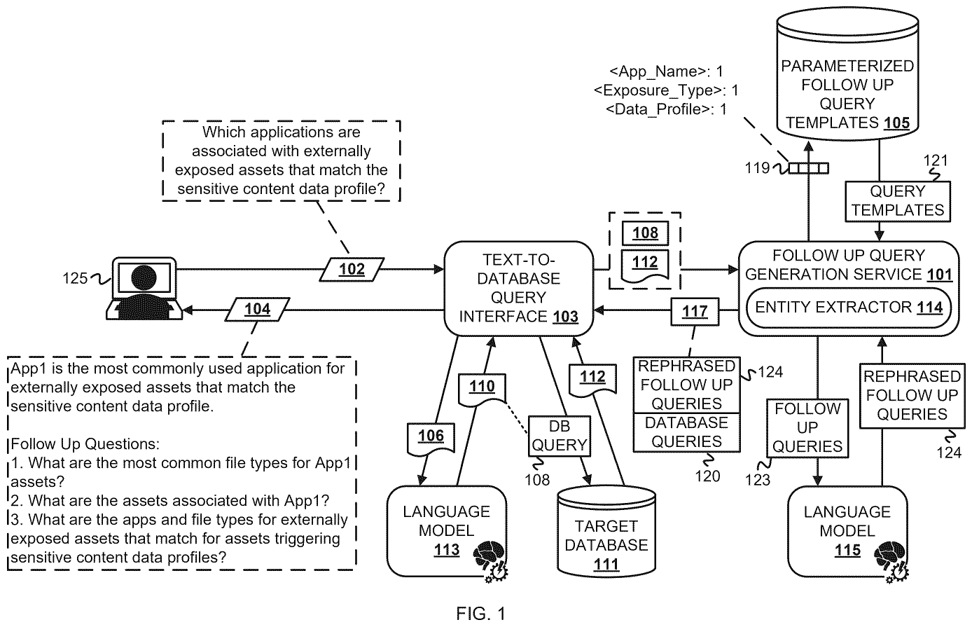

FIG. 1 is a conceptual diagram of an overview of generating follow up queries as part of fulfilling user queries with text-to-database query conversion. In this example, a user 125 submits queries comprising natural language to a text-to-database query interface (“query interface”) 103 (e.g., via a client device). The query interface 103 responds to user queries by converting a user query to a database query representation thereof, executes the database query against a target database 111 (e.g., a production database), and generates a response to the user query based on the results of executing the database query. The query interface 103 also obtains follow ups to the user query from a follow up query generation service (“service”) 101 for incorporation into generated responses to user queries. The service 101 generates follow ups to a user query based on context provided by the corresponding database query and the database query execution results. Follow ups that the service 101 generates include follow up queries comprising natural language and their corresponding database queries.

The user 125 submits a query 102 to the query interface 103. The query 102 comprises the text, “Which applications are associated with externally exposed assets that match the sensitive content data profile?” The query interface 103 prompts a language model 113 to generate a database query that represents the query 102 and is compatible with the target database 111. The query interface 103 constructs a prompt 106 comprising the natural language text extracted (e.g., copied) from the query 102 and an instruction to perform the task of converting the text to a database query, such as to a SQL query. For instance, the query interface 103 may be configured with a prompt template that comprises example pairs of queries comprising natural language and corresponding database queries and other information to aid the language model 113 in performing this task, such as information about a schema of the target database 111, descriptions of tables and/or fields of the target database 111, etc. The query interface 103 obtains a response 110 to the prompt 106 that comprises a database query 108 that represents the query 102. The query interface 103 queries the target database 111 with the database query 108 to obtain a result 112 comprising data from the target database 111 that satisfy the database query 108, if any, and that are thus the raw data expected to fulfill the query 102.

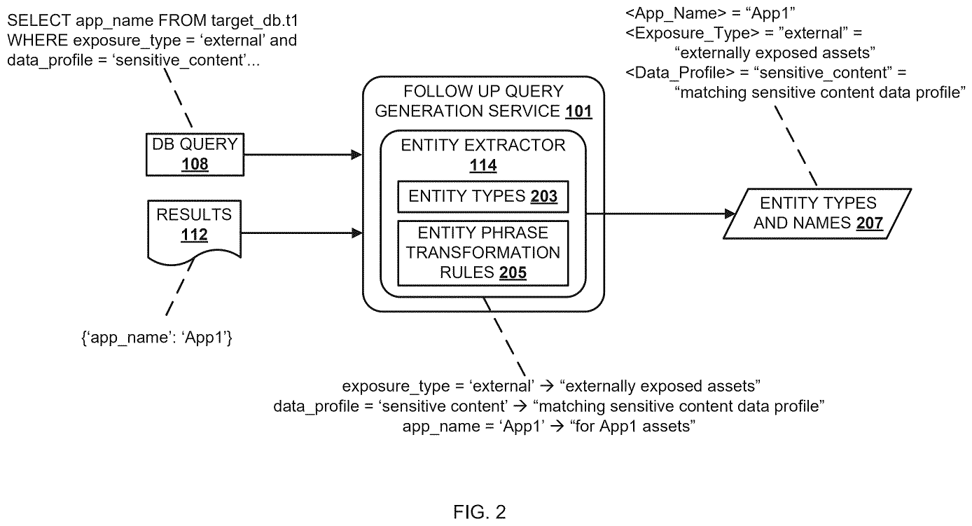

The query interface 103 provides the service 101 with the database query 108 and the result 112 (e.g., via an application programming interface (API) of the service 101). The service 101 comprises an entity extractor 114 that extracts entity types and names from the database query 108 and/or the result 112. Entity extraction for retrieval of query templates is described in further detail in reference to FIG. 2, though in this example, the entity extractor 114 extracts three entity types from the database query 108 and the results 112: “App_Name”, “Exposure_Type”, and “Data_Profile”. These entity types are assumed to have corresponding entity names of “App1”, “external”, and “sensitive_content”. This illustrative example is expounded upon in FIG. 2.

The service 101 generates a vector 119 that indicates the entity types extracted from the database query 108 and the result 112. The vector 119 may be a one-hot vector indicating a value of one for each entity type extracted from the database query 108 and the result 112 (i.e., “App_Name”, “Exposure_Type”, and “Data_Profile”) and a value of zero for other entity types. The vector 119 may be weighted, where weights are assigned based on rules and/or heuristics for weighting certain entity types (e.g., that were defined based on expert/domain knowledge). The service 101 queries a database 105 of parameterized follow up query templates (“template database 105”) with the vector 119. The template database 105 comprises pairs of parameterized user query templates and database query templates, where parameters of each user query template and database query template correspond to entity types recognized by the entity extractor 114. The template database 105 may be a vector database, where each user query template and database query template pair is associated with a vector indicating entity types that are represented with parameters in the template pair. The service 101 thus queries the template database 105 for a set of N most similar template pairs based on their associated vectors (e.g., in terms of cosine similarity between the vectors). The service 101 obtains N query templates 121 from the template database 105 and populates each of the template parameters of the user and database query templates with the corresponding entity name extracted from the respective one of the database query 108 and the result 112. Populating the query templates 121 results in follow up queries 123 and their corresponding database queries 120.

The service 101 prompts a language model 115 to rephrase the follow up queries 123 to obtain rephrased follow up queries 124. Since those of the query templates 121 corresponding to user query templates were populated with entity names extracted from the database query 108 and/or the results 112, which were initially represented with database query language rather than natural language, rephrasing the follow up queries 123 ensures that the entity names are represented in the follow up queries with natural language that emulates the text that would be input by a user. The prompt to the language model 115 can indicate the follow up queries 123 and a task instruction to rephrase each of the follow up queries 123. The service 101 can also execute a dry run for the database queries 120 to ensure that they are executable against the target database 111 should the user 125 select one of the corresponding rephrased follow up queries 124. If the dry run of any of the database queries 120 is unsuccessful, the service 101 can discard the unsuccessfully executed database query(ies) and corresponding user query(is) or omit the database query(ies) and corresponding user query(ies) from consideration.

The service 101 provides the query interface 103 with a set 117 of follow ups comprising the rephrased follow up queries 124 and the database queries 120. Based on this, the query interface 103 generates a response 104 to the query 102. The response 104 comprises the rephrased follow up queries 124 and a response to the original query 102 that the query interface 103 generated based on the results 112 of executing the database query 108. The query interface 103 communicates the response 104 to the user 125 (e.g., via displaying on a graphical user interface (GUI), a chatbot interface, etc.). In this example, the rephrased follow up queries 124 indicated in the response 104 include three follow up queries: “What are the most common file types for Appl assets?”, “What are the assets associated with App1?”, and “What are the apps and file types for externally exposed assets that match for assets triggering sensitive content data profiles?”. If the user 125 selects any of the rephrased follow up queries 124, the selected follow up query is submitted to the query interface 103, and the corresponding one of the database queries 120 can be directly executed against the target database 111. This reduces cost associated with responding to user queries since the database query has already been pre-generated based on populating the corresponding one of the query templates 121 rather than based on prompting the language model 113 to generate a database query from the follow up query.

While not described in detail in reference to FIG. 1, the query interface 103 or another entity with which the query interface 103 communicates can determine the table of the target database 111 to which the query 102 is most relevant before prompting the language model 113. For instance, the query interface 103 (or other entity) can perform intent classification to classify the query 102 as corresponding to a certain table of the target database 111.

FIG. 2 is a conceptual diagram of extracting entity types and names from a database query and results of executing the database query against a target database. Extracted entity names are used to populate user query templates and the corresponding database query templates that are retrieved for generation of follow up queries. FIG. 2 depicts the service 101 and the entity extractor 114 of FIG. 1. FIG. 2 also depicts examples of the database query 108 and results 112 in additional detail. The database query 108 is a SQL query comprising a SELECT statement that selects data from the field “app_name” from the example table “target_db.t1”. The database query 108 also comprises a WHERE statement to filter for results where the value of “exposure_type” is “external” and the value of “data_profile” is “sensitive_content”. The results 112 comprise data from the target database 111 of FIG. 1 that satisfy the database query 108, or the value “App1” of “app_name”.

The entity extractor 114 comprises a set of entity types 203. The entity types 203 correspond to fields of the target database 111 that are to be extracted from database queries with their corresponding values, which are considered the entity names. The entity types 203 have been determined based on expert/domain knowledge. In this example, the entity types 203 indicate the target database 111 fields “app_name”, “exposure_type”, and “data_profile” included in the database query 108. The entity extractor 114 extracts (e.g., copies) the entity types “exposure_type” and “data_profile” and the corresponding entity names “external” and “sensitive_content”, respectively, from the WHERE statement of the database query 108. The entity extractor 114 extracts the entity type “app_name” from the SELECT statement of the database query 108 and extracts the corresponding entity name, “App1”, from the results 112. Generally, if one of the entity types 203 is included in a WHERE statement of a SQL query, the entity extractor 114 extracts both the entity type and the corresponding entity name from the WHERE statement. If one of the entity types 203 is included in a SELECT statement of a SQL query, the entity extractor 114 extracts the entity type from the SELECT statement and extracts the corresponding entity name from the results of executing the database query. The entity extractor 114 can extract entity types and names from SQL WHERE statements so long as a valid database query is generated and provided to the service 101 and can extract entity types from SQL SELECT statements and their corresponding entity names from execution results if the database query comprising the SELECT statement was executed to produce a non-empty or nonzero results set, i.e., there are values in the results set that can be matched to an entity type in the SELECT statement.

The entity extractor 114 also comprises entity phrase transformation rules (“rules”) 205. The rules 205 comprise rules for transforming entity types and names into natural language phrases that will later be used to populate user query templates as described in reference to FIG. 1. The rules 205 can be defined per table of the target database 111 and have been defined based on expert/domain knowledge. For instance, the rules 205 can indicate an ordering of entity types and names that should be used to convert entity types and names to phrases for certain tables and/or fields of the target database 111, can indicate that certain syntax elements should be removed from extracted entity types and names, etc. In this example, the entity extractor 114 transforms the entity type/name pair “exposure type” and “external” to the phrase “externally exposed assets” based on applying applicable ones of the rules 205 to this entity type/name pair extracted from the database query 108. The entity extractor 114 also transforms the entity type/name pair “data profile” and “sensitive content” to the phrase “matching sensitive content data profile” based on applying applicable ones of the rules 205 to this entity type/name pair. The entity extractor 114 also transforms the entity type/name pair “app_name” and “App1” to the phrase “for App1 assets” based on applying applicable one of the rules 205 to this entity type/name pair.

The entity extractor 114 generates entity types and names 207 as a result of extracting the entity types and names from the database query 108 and results 112 and transforming the entity types/names into phrases based on the rules 205. The entity types and names 207 comprise the entity types extracted from the database query 108 that correspond to parameters of the query templates 121 of FIG. 1. The entity types and names 207 also comprise the entity names extracted from the database query 108 and the results 112 as well as the natural language phrases representing the entity types/names. The service 101 will then populate the database query template parameters corresponding to entity types “App_Name”, “Exposure_Type”, and “Data_Profile” with the entity names “App1”, “external”, and “sensitive_content”, respectively, and will populate the user query template parameters corresponding to these entity types with the natural language phrases “for App1 assets”, “externally exposed assets”, and “matching sensitive content data profile”. This produces an executable database query formed from populating a database query template and a corresponding natural language representation that emulates text input by a user as a result of populating the user query template with the natural language phrases representing the entity types/names.

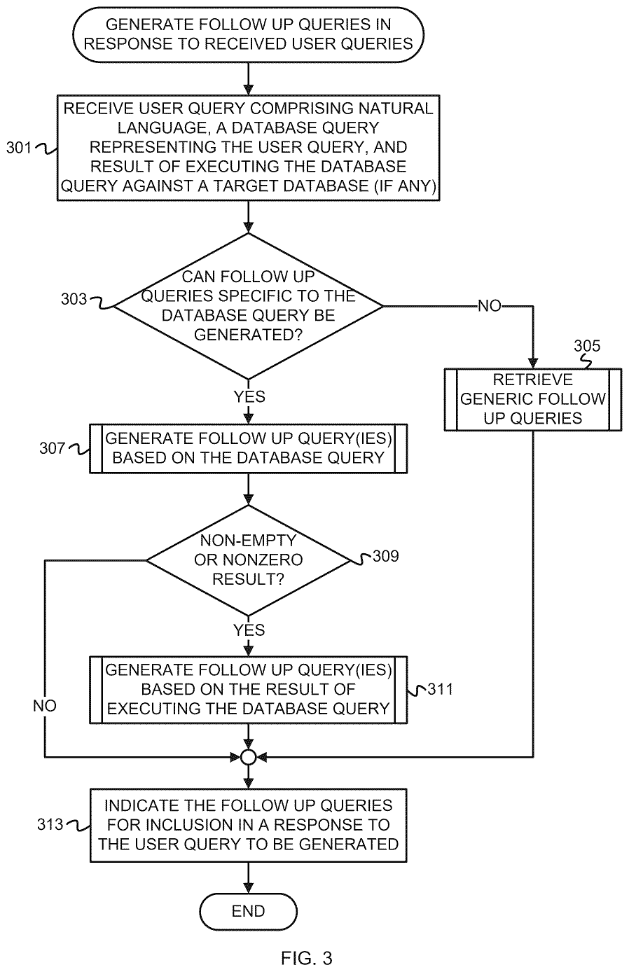

FIGS. 3-7 are flowcharts of example operations. The example operations are described with reference to a follow up query generation service (hereinafter “the service” for brevity) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for generating follow up queries in response to received user queries. The example operations assume that the service communicates with another service (e.g., via a respective API) that generates database queries representative of user queries based on prompting a foundation model, such as an LLM, to perform this task. The database queries should be compatible with a target database, such as a production database of a vendor, cybersecurity service, etc.

At block 301, the service receives a user query comprising natural language, a database query representing the user query, and a result of executing the database query against the target database, if any. The database query should be written in a database query language used for querying the target database, such as SQL. The result of executing the database query may comprise any data maintained in the target database that satisfied the database query and thus satisfy the user query or may comprise an empty set or a value of zero if no data in the target database satisfied the database query.

At block 303, the service determines if follow up queries specific to the database query can be generated. Various criteria can be configured based on which the service determines if follow up queries specific to the database query can be generated. One such criterion can be a criterion that a result of executing the database query is actually obtained. Execution results may not be obtained if the database query could not be executed against the target database and/or if the user query could not be successfully converted to a database query. If either of these are the case, the service can obtain an error message indicating an error code, text indicating that an error occurred, etc. The service determines that follow up queries specific to the database query can be generated if the database query was successfully generated and executed against the target database to obtain a result. As another example, some database queries may not include any entity types recognized by the service and thus do not include any information that can be extracted therefrom to generate a follow up query. In this case where the service searches the database query for any recognized entity types indicated therein and does not identify any in the database query, the service determines that a follow up query specific to the database query cannot be generated. If follow up queries specific to the database query cannot be generated, operations continue at block 305. If follow up queries specific to the database query can be generated, operations continue at block 307.

At block 305, the service retrieves generic follow up queries. Generic follow up queries are predefined queries that can be provided in response to a user query in the event of an error in generating or executing the database query from a user query.

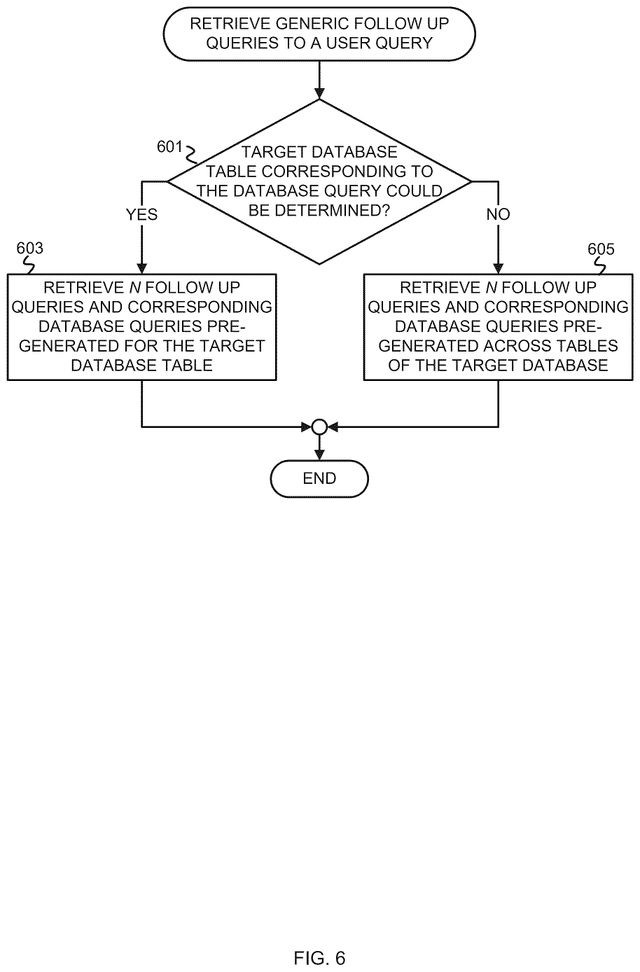

Retrieval of generic follow up queries is described in further detail in reference to FIG. 6.

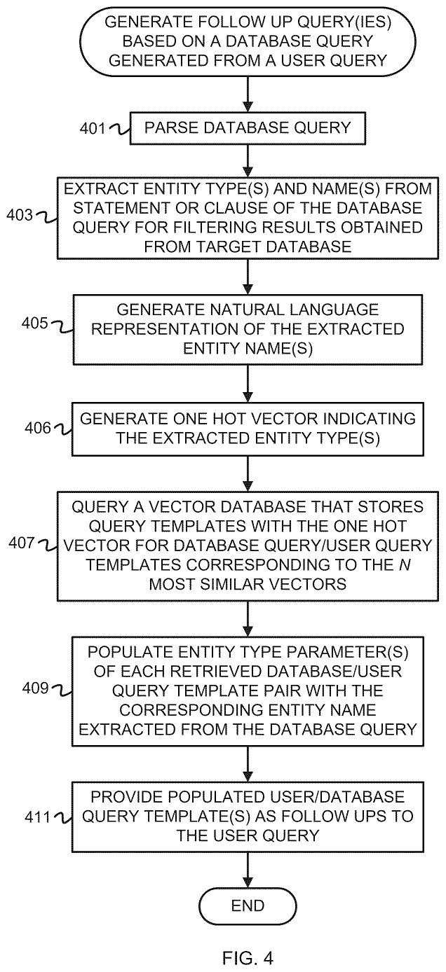

At block 307, the service generates one or more follow up queries based on the database query. The number of follow up queries to be generated based on the database query can be indicated in a configuration of the service or provided as a parameter value. The service extracts one or more entity types and names from the database query, retrieves one or more user/database query template pairs corresponding to the extracted entity type(s), and populates each parameter of the query template pairs corresponding to an entity type with the respective entity name. The result is a follow up query(ies) populated with information extracted from the database query and a corresponding database query(ies) populated similarly. Generating follow up queries based on a database query is described in further detail in reference to FIG. 4.

At block 309, the service determines if the result of executing the database query is non-empty or nonzero. In some cases, none of the data in the target database may satisfy the database query, and the result will thus indicate an empty set or a value of zero. If executing the database query produced a non-empty or nonzero result (i.e., data that satisfy the database query were retrieved from the target database), one or more additional follow up queries can be generated based on information additionally identified from the execution result. If the result is non-empty or nonzero, operations continue at block 311. Otherwise, operations continue at block 313.

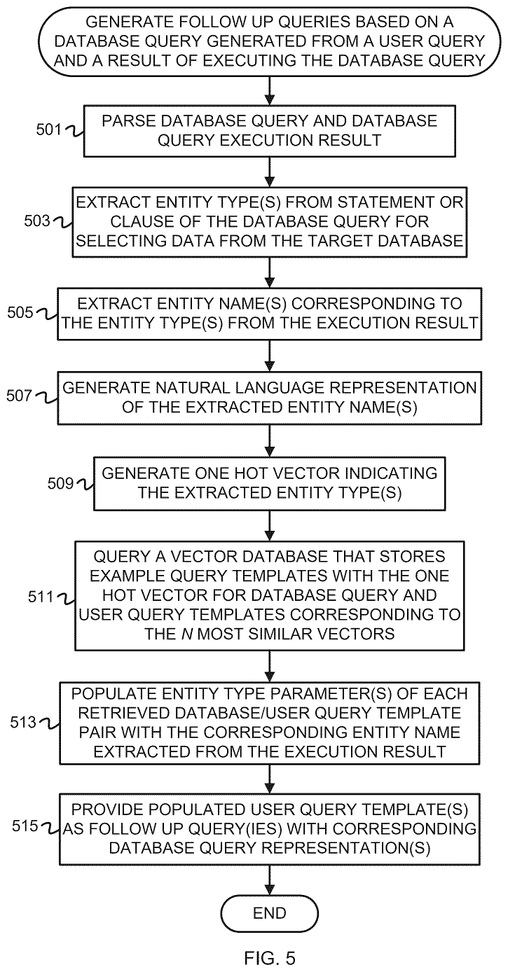

At block 311, the service generates one or more follow up queries based on the result of executing the database query. The number of follow up queries to be generated based on the database query and its execution result can be indicated in a configuration of the service or provided as a parameter value. The service extracts one or more entity types from the database query, extracts a corresponding one or more entity names corresponding to the entity type(s) from the execution result, retrieves one or more user/database query template pairs corresponding to the extracted entity type(s), and populates each parameter of the query template pairs corresponding to an entity type with the respective entity name. The result is a follow up query(ies) populated with information extracted from the database query and execution result and a corresponding database query(ies) populated similarly. Generating follow up queries based on a database query and its execution result is described in further detail in reference to FIG. 5.

At block 313, the service indicates the follow up queries for inclusion in a response to the user query that is to be generated. If more follow up queries were generated than are to be supplied in responses to user queries (e.g., as indicated in a configuration of the service), the service can select a subset of the generated follow up queries to indicate for responding to the user query. When selecting the subset of follow up queries, the service may prioritize follow up queries generated based on both the database query and its execution result if such follow up queries could be generated (i.e., as described at block 309). To illustrate, if three follow up queries should be provided in response to user queries, the service can select one of the follow up queries generated based on the database query and two of the follow up queries generated based on the database query and its execution result. Selection from the sets corresponding to each type of follow up query, or the set of follow up queries generated based on the database query and the set generated based on both the database query and the execution result, can be random. If the service retrieved generic follow up queries rather than generating follow up queries specific to the database query (and its execution result, if any), the service can return one or more generic follow up queries that are presented to the user as options for proceeding in addition to an error message, a request to try again due to the error in servicing the user request, etc.

FIG. 4 is a flowchart of example operations for generating follow up queries based on a database query that has been generated from a user query. A database query that represents a user query and that is compatible with a target database has been generated. For instance, the database query may be a SQL query.

At block 401, the service parses the database query. The service can convert the database query into a format that can be readily searched, for instance by splitting the database query into tokens.

At block 403, the service extracts one or more entity types and names from a statement or clause of the database query for filtering results obtained from the target database. Often, this statement/clause will be a SQL WHERE statement. Entity types correspond to fields of the target database, and entity names correspond to data stored in those fields. Target database fields that are considered entity types have been predetermined, such as based on expert/domain knowledge. The service extracts one or more of the recognized entity types included in this statement/clause of the database query (e.g., from the SQL WHERE statement) and their corresponding values as the entity names. Extracted entity types and the corresponding entity names can be represented as fields of the target database and their values indicated in the statement/clause of the database query for results filtering.

At block 405, the service generates a natural language representation of each extracted entity name(s). Since the service extracted the entity name from the database query, which is written in a database query language, the service generates a natural language representation of each extracted entity name that is closer to natural language. The service can be configured with rules for transforming entity names corresponding to entity types to natural language representations thereof. These rules may be defined per table for the target database and have been previously defined based on expert/domain knowledge.

At block 406, the service generates a one hot vector indicating the one or more extracted entity types. The one hot vector comprises a plurality of elements corresponding to a plurality of entity types recognized by the service. Elements of the vector corresponding to the extracted entity types have a value of one (or a nonzero value in the case of a weighted vector) assigned by the service, and all other elements corresponding to entity types not extracted from the database query are assigned a value of zero. The one hot vector may be a weighted vector, where weights of certain entity types represented in the one hot vector have been determined based on expert/domain knowledge. As an illustrative example, entity types related to date, size, and/or frequency may be associated with lower weights, while entity types related to username, email address, and/or application name may be associated with higher weights. Weighting entity types in the one-hot vector allows for prioritizing retrieval of database query/user query templates with “important” (i.e., higher weighted) entity types when subsequently querying a vector database for the templates corresponding to the most similar vector(s) to the one-hot vector.

At block 407, the service queries a vector database that stores query templates with the one hot vector for the database query/user query template pairs corresponding to the N most similar vectors stored in the database. The value of N may be indicated in a configuration of the service or provided as a parameter value. Vectors stored in the database can be weighted one-hot vectors indicating entity types represented with parameters in the corresponding database/user query pair. The database query/user query template pairs can be associated with the vectors in corresponding entries of the vector database.

At block 409, the service populates the entity type parameter(s) of each retrieved database/user query template pair with the corresponding entity name extracted from the database query. Each user query template and associated database query template retrieved from the vector database comprises one or more parameters that each correspond to an entity type. The service populates the user query template parameter(s) with the respective entity name(s) extracted from the database query, which may have been converted to a natural language representation thereof following extraction from the database query. The service also populates the database query template parameter(s) with the respective entity name(s), which may be the raw entity name extracted from the database query (i.e., without conversion to natural language). If multiple entity names were extracted for the same entity type, the service can populate the entity type parameter(s) with a randomly selected one of the entity names or can populate the entity type parameter(s) with each entity name joined by an “OR” or similar keyword (e.g., values of “user1” and “user2” for the entity type “username” could be represented as “user1 or user2” in the user query and “user=‘user1’ OR user=‘user2’” in the database query that the service generates through population of entity type parameters).

At block 411, the service provides the populated user query template(s) and the corresponding database query template(s) as follow ups to the user query. The service can generate a notification indicating the populated user/database query templates, store the populated user/database query templates (e.g., in a database), or otherwise make the populated user/database query templates available for generation of a response to the user query that comprises the populated user query template(s).

FIG. 5 is a flowchart of example operations for generating follow up queries based on a database query generated from a user query and a result of executing the database query. As with FIG. 4, a database query that represents a user query and that is compatible with a target database has been generated. For instance, the database query may be a SQL query. Some example operations and details of example operations are repeated between FIGS. 4 and 5. These details are not repeated in FIG. 5 for brevity.

At block 501, the service parses the database query and the database query execution result. The service can convert the database query into a format that can be readily searched, such as by splitting the database query into tokens and/or generating a JavaScript® object from a JavaScript® Object Notation (JSON) formatted execution result.

At block 503, the service extracts one or more entity types from a statement or clause of the database query for selecting data from the target database. Often, this statement/clause will be a SQL SELECT statement. The service extracts one or more of the recognized entity types included in this statement/clause of the database query (e.g., from the SQL SELECT statement). Extracted entity types can be represented as field names of the target database.

At block 505, the service extracts from the execution result one or more entity names corresponding to the one or more extracted entity types. Entity names corresponding to entity types indicated in a statement/clause such as a SELECT statement of a database query are included in an execution result rather than in the database query itself. The service identifies the data indicated in the execution result that corresponds to the extracted entity type(s) and extracts the corresponding entity name(s) from the execution result. Extracted entity types and the corresponding entity names can be represented as fields of the target database indicated in the statement of the database query for selecting data and their values indicated in the database query execution result.

At block 507, the service generates a natural language representation of each extracted entity name. At block 509, the service generates a one hot vector indicating the extracted entity type(s). At block 511, the service queries a vector database that stores query templates with the one hot vector for the database query/user query template pairs corresponding to the N most similar vectors stored in the database. At block 513, the service populates the entity type parameter(s) of each retrieved database/user query template pair with the corresponding entity name extracted from the execution result. At block 515, the service provides the populated user query template(s) and the corresponding database query template(s) as follow ups to the user query. The service can generate a notification indicating the populated user/database query templates, store the populated user/database query templates (e.g., in a database), or otherwise make the populated user/database query templates available for generation of a response to the user query that comprises the populated user query template(s).

FIG. 6 is a flowchart of example operations for retrieving generic follow up queries to a user query. The example operations can be performed in lieu of generating follow up questions based on context provided by a database query (and optionally its execution result) as described in reference to FIGS. 4 and 5, such as in cases where a database query is not executable or does not indicate any entity types that can be extracted.

At block 601, the service determines if a table of the target database corresponding to the database query could be determined. A table of the target database may have been initially predicted based on intent classification of the database query, though in implementations, a table of the target database may not be able to be predicted (e.g., if the user query is not comprehensible). As another example, the database query may indicate a table of the target database if the database query corresponds to a table that is present in the target database (e.g., in a SQL FROM statement). If a target database table could be determined, operations continue at block 603. If not, operations continue at block 605.

At block 603, the service retrieves N follow up queries and corresponding database queries pre-generated for the table of the target database. The service has access to a database that maintains user/database query pairs for each table of the target database that, unlike the user/database query template pairs described above, are not templatized and thus need not be populated before being provided to a user. The user/database query pairs have been defined for the target database table previously based on expert/domain knowledge. The service queries the database that stores the user/database query pairs for a set of N randomly selected user/database query pairs that correspond to the table of the target database. The value of N may be indicated in a configuration of the service or provided as a parameter value.

At block 605, the service retrieves N follow up queries and corresponding database queries pre-generated across tables of the target database. The service queries the database that stores the user/database query pairs for a set of N randomly selected user/database query pairs. These user/database query pairs can correspond to any table of the target database.

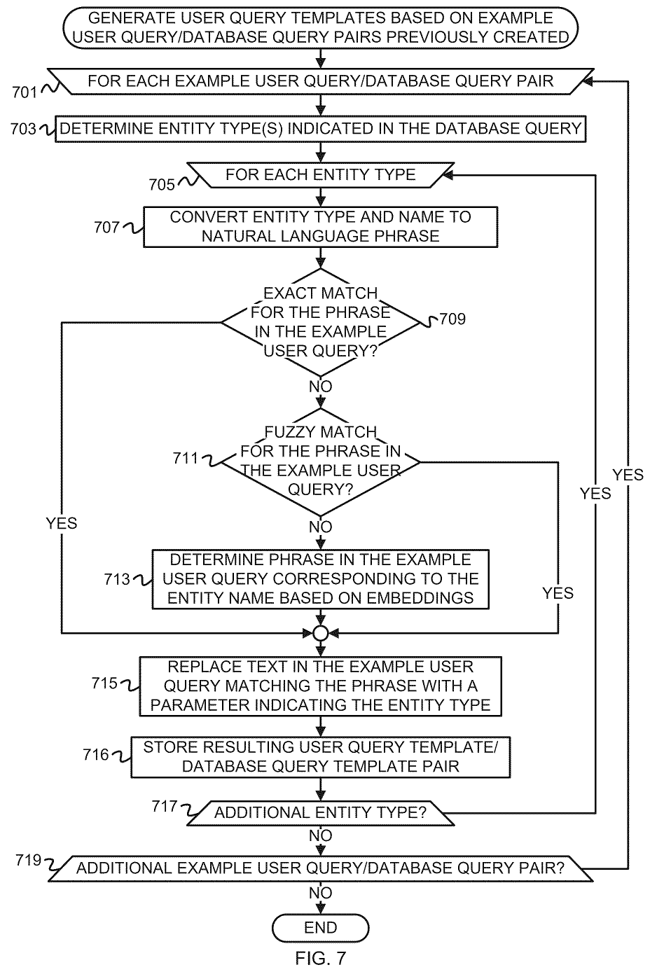

FIG. 7 is a flowchart of example operations for generating user query templates based on example pairs of user queries and database queries that have previously been created. The example operations assume that a plurality of pairs of example user queries and their corresponding database queries have already been created, and each database query has a corresponding database query template defined. A template for a database query indicates one or more placeholders for values of a corresponding one or more database field names used in the database query (i.e., placeholders for entity names corresponding to entity types indicated in the database query). Database query templates have been previously created based on expert/domain knowledge.

At block 701, the service begins iterating through each example user query/database query pair. Each example user query/database query pair comprises an example of a user query that comprises natural language and a corresponding database query representation (e.g., a corresponding SQL query).

At block 703, the service determines one or more entity types that are indicated in the database query. The service determines one or more entity types that correspond to fields of the target database that are indicated in the database query. The fields of the target database that the service recognizes as entity types have been previously determined (e.g., based on expert/domain knowledge). The service can extract each entity type and corresponding name from the database query. At block 705, the service begins iterating through entity types determined to be indicated in the database query.

At block 707, the service converts the entity type and corresponding entity name to a natural language phrase. The service generates a phrase comprising a natural language representation of the entity type and name based on rules defined for the table of the target database (e.g., based on expert/domain knowledge). The rules can be defined for each entity type corresponding to the target database table indicated in the database query or can be represented generally and encompass entity types included in the table. To illustrate, for an entity name “document” corresponding to an entity type of “file type” extracted from the database query as “file_type=‘document’”, the service can convert the entity type and name to a natural language phrase “document file types”. Entity names and types can be transformed to natural language based on reordering individual words included in the extracted entity type/name, removing non-natural language syntax extracted from the database query, and/or replacing database query syntax with natural language words or phrases (e.g., “_” and “=” in the aforementioned example), etc. As an illustrative example, the service can convert an extracted entity type and name “LOWER(data_profiles.name)=‘legal custom’”, in which the entity type is “data_profiles.name” and the name is “legal custom”, to the phrase “matching legal custom profile” based on a rule defined for the corresponding target database table. As another illustrative example, for a database query comprising an entity type and name “asset size<100000”, the service can convert this entity type/name to the phrase “for asset size less than 100 KB” based on a rule that transforms symbols to their natural language equivalents and converts numbers pertaining to size to labeled units (e.g., 100000 to 100 KB in this example).

At block 709, the service determines if an exact match for the phrase can be identified in the example user query. The service may generate a regular expression representing the phrase and determine if one or more substrings or tokens of the example user query match the regular expression. The substring(s)/token(s) that match the regular expression are identified as an exact match to the phrase. If an exact match can be identified, operations continue at block 715. Otherwise, operations continue at block 711.

At block 711, the service determines if a fuzzy match for the phrase can be identified in the example user query. Fuzzy matching techniques can include checking for similar words in the example user query based on a token sort ratio, checking for similar numerical values and ignoring minor differences due to rounding (e.g., “3” and “3.0” would be identified as a fuzzy match), and checking for words with similar meanings based on lemmatization. As an illustrative example, consider a user query “What are the apps and owner emails for assets that match the legal custom profile?” In the aforementioned example where the service generates the phrase “matching legal custom profile” from “LOWER(data_profiles. name)=‘legal custom’”, the service identifies a fuzzy match between “matching legal custom profile” and “match the legal custom profile” in the user query. If a fuzzy match can be identified, operations continue at block 715. Otherwise, operations continue at block 713.

At block 713, the service determines a phrase in the example user query that corresponds to the entity name using embeddings. The service removes any punctuation from the example user query and parses the example user query into individual substrings corresponding to words. The service also generates an embedding of the phrase, such as with a sentence transformer or other pre-trained and/or off-the-shelf model that generates text embeddings. The service then generates n-grams of the example user query for values of N from a minimum to a maximum number of substrings (e.g., by generating unigrams, bigrams, trigrams, etc. of the example user query). For each n-gram of the example user query, the service generates an embedding therefrom and computes a measure of similarity that represents semantic similarity (e.g., with cosine similarity) between the embedding and the phrase embedding. The n-gram of the example user query having an embedding with the highest computed similarity with the phrase embedding is selected as the best match to the phrase. The service may identify the n-gram with the greatest similarity as the match to the phrase if the computed similarity satisfies a threshold; if the computed similarity does not satisfy the threshold, the service may omit the entity type from template generation (i.e., subsequent example operations performed for the entity type can be omitted).

At block 715, the service replaces the text in the example user query that matches the phrase with a parameter indicating the entity type. The text that matches the phrase comprises one or more substrings that was either an exact match, a fuzzy match, or an embeddings-based match with the phrase. Returning to the previous example, the service can replace the phrase “legal custom profile” in the user query with a parameter representing the entity type “data_profiles.name” to produce the parameterized user query “What are the apps and owner emails for assets that match the <data_profiles.name>?”

At block 716, the service stores the resulting user query template and database query template pair. The service stores the templates for subsequent retrieval and population with information extracted from database queries and/or database query execution results. The service can generate a one-hot vector indicating the entity types represented with parameters in the templates and associates the vector with the templates for insertion into a vector database. Weights may be assigned to one or more entity types represented in the one-hot vector, with weight assignments determined based on expert/domain knowledge.

At block 717, the service determines if there is an additional entity type indicated in the database query. If there is an additional entity type, operations continue at block 705. Otherwise, operations continue at block 719.

At block 719, the service determines if there is an additional example user query/database query pair remaining for user query template generation. If there is an additional pair comprising an example user query and a corresponding database query, operations continue at block 701. Otherwise, operations are complete.

### Variations

The Figures and description refer to SQL queries in illustrative examples.

Implementations are applicable to other database query languages and are not necessarily limited to database query languages used for relational databases. For instance, implementations can generate follow up queries based on database queries (and optionally database query execution results) written in a proprietary database query language.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

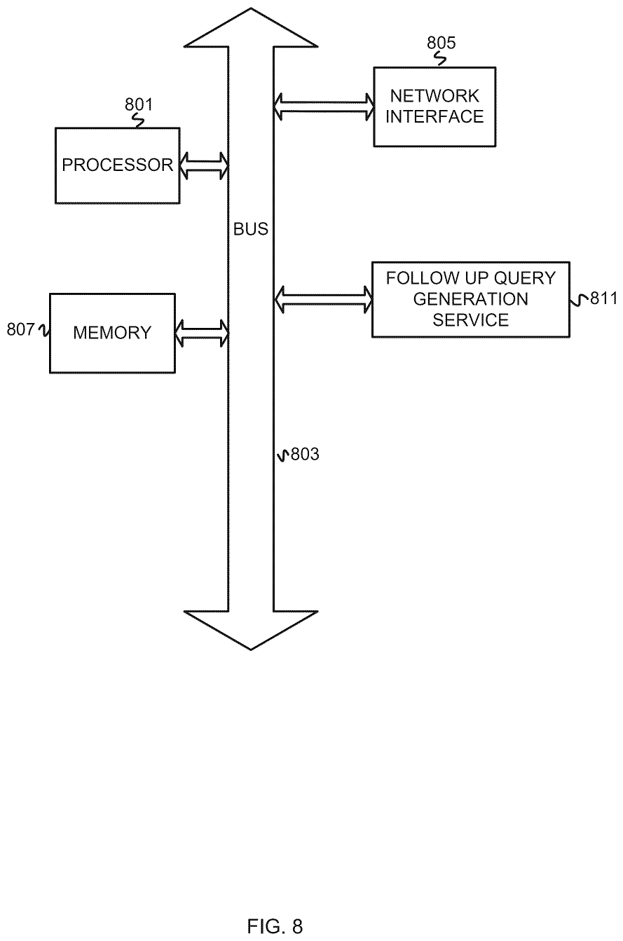

FIG. 8 depicts an example computer system with a follow up query generation service. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes follow up query generation service 811. The follow up query generation service 811 generates follow up queries and corresponding database queries based on received user queries and their representative database queries. The follow up query generation service 811 can generate follow up queries and corresponding database queries based on populating user/database query templates with names of entities extracted from database queries generated from user queries and the corresponding execution results. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

1. A method comprising:
obtaining a first user query comprising natural language and a first database query representing the first user query, wherein the first database query corresponds to a target database;
based on extracting one or more entity types from the first database query, retrieving one or more user query templates from a plurality of user query templates,
wherein each of the one or more user query templates comprises one or more parameters corresponding to the one or more entity types;
generating one or more follow up queries for the first user query, wherein
generating the one or more follow up queries comprises,
extracting one or more entity names corresponding to the one or more entity types from at least one of the first database query and a result of executing the first database query against the target database; and
populating each of the one or more user query templates based on the one or more entity names; and
responding to the first user query with a first response comprising the one or more follow up queries.

2. The method of claim 1,
wherein retrieving the one or more user query templates further comprises retrieving a corresponding one or more database query templates,
and wherein generating the one or more follow up queries further comprises populating parameters of each of the one or more database query templates with the one or more entity names extracted from at least one of the first database query and the result of executing the first database query.

3. The method of claim 1, wherein extracting the one or more entity types from the first database query comprises extracting the one or more entity types from at least one of a first statement in the first database query for selecting data from the target database and a second statement in the first database query for filtering the result obtained from executing the first database query.

4. The method of claim 3, wherein extracting the one or more entity names corresponding to the one or more entity types from at least one of the first database query and the result of executing the first database query against the target database comprises,
for each of the one or more entity types extracted from the first statement in the first database query, extracting corresponding ones of the one or more entity names from the result obtained from executing the first database query; and
for each of the one or more entity types extracted from the second statement in the first database query, extracting corresponding ones of the one or more entity names from the second statement.

5. The method of claim 3, wherein the first database query comprises a Structured Query Language (SQL) query, wherein extracting the one or more entity types from at least one of the first statement in the statement in the database query for selecting data from the target database and the second statement in the database query for filtering the result obtained from executing the database query comprises extracting the one or more entity types from at least one of a SELECT statement in the SQL query and a WHERE statement in the SQL query.

6. The method of claim 1, further comprising generating a weighted one-hot vector based on the one or more entity types, wherein a vector database maintains a plurality of vectors generated based on the plurality of user query templates, wherein retrieving the one or more query templates comprises querying the vector database with the weighted one-hot vector for one or more of the plurality of vectors most similar to the weighted one-hot vector.

7. The method of claim 1, further comprising generating the plurality of user query templates based on a plurality of user queries and a corresponding plurality of database queries, wherein generating the plurality of user query templates comprises, for each user query of the plurality of user queries and corresponding database query from the plurality of database queries,
extracting one or more entity types and names from the database query; and
for each entity type and name of the one or more entity types and names extracted from the database query, determining one or more substrings of the user query to which the entity type and name corresponds and replacing the one or more substrings in the user query with a parameter corresponding to the type of the entity to generate a corresponding one of the plurality of user query templates.

8. The method of claim 7, wherein determining the one or more substrings of the user query comprises determining the one or more substrings based on at least one of identifying an exact match between the entity type and name and the one or more substrings, based on fuzzy matching of the entity and the one or more substrings, and based on generating a vector representation of the entity type and name and vector representations of substrings of the user query and determining a most similar one of the vector representations of the substrings of the user query to the vector representation of the entity type and name.

9. The method of claim 1, wherein extracting the one or more entity types and extracting the one or more entity names comprises extracting the one or more entity types and the one or more entity names from the first database query based on determining that the result of executing the first database query comprises an empty results set or a value or zero.

10. The method of claim 1 further comprising, based on determining that no entity types and names can be extracted from the first database query, retrieving one or more predefined follow up questions and responding to the first user query with a second response comprising the one or more predefined follow up questions.

11. The method of claim 1, wherein the first database query representing the first user query was generated by a first language model based on the first user query, and wherein responding to the first user query comprises prompting a second language model to rephrase each of the one or more follow up queries and responding to the first user query with the rephrased one or more follow up queries.

12. The method of claim 1, wherein the first database query indicates a first table of the target database, and wherein each of the one or more user query templates corresponds to the first table of the target database.

13. One or more non-transitory machine-readable media having program code stored thereon, the program code comprising instructions to:
extract one or more entity types from a database query, wherein the database query was generated based on a user query comprising natural language and corresponds to a target database;
extract one or more entity names corresponding to the one or more entity types from at least one of the database query and a result of executing the database query against the target database;
retrieve a set of parameterized user query templates from a plurality of user query templates based on the one or more entity types extracted from the database query and a table of the target database indicated in the database query;
generate a plurality of follow up queries to the user query, wherein the instructions to generate the plurality of follow up queries comprise instructions to populate each of the set of parameterized user query templates with the one or more entity names; and
provide the plurality of follow up queries in a response to the user query.

14. The non-transitory machine-readable media of claim 13,
wherein the instructions to retrieve the set of parameterized user query templates further comprise instructions to retrieve a corresponding set of database query templates,
and wherein the instructions to generate the plurality of follow up queries further comprise instructions to populate parameters of each of the set of database query templates with the one or more entity names.

15. The non-transitory machine-readable media of claim 13, wherein the instructions to extract the one or more entity types from the database query and to extract the one or more entity names from the database query comprise instructions to extract the one or more entity types and the one or more entity names from a Structured Query Language (SQL) SELECT statement of the database query.

16. The non-transitory machine-readable media of claim 13,
wherein the instructions to extract the one or more entity types from the database query comprise instructions to extract the one or more entity types from a SQL WHERE statement of the database query,
and wherein the instructions to extract the one or more entity names corresponding to the one or more entity types from the result of executing the database query comprise instructions to extract the one or more entity names from the result of executing the database query.

17. An apparatus comprising:
a processor; and
a machine-readable medium having instructions stored thereon that are executable by the processor to cause the apparatus to,
obtain a user query comprising natural language and a database query representing the user query;
based on extraction of one or more entity types from the database query, retrieve one or more parameterized user query templates from a plurality of parameterized user query templates,
wherein each of the one or more parameterized user query templates corresponds to a first table of a target database indicated in the database query;
generate one or more follow up queries for the user query, wherein the instructions to generate the one or more follow up queries comprise instructions to populate each of the one or more parameterized user query templates with a name of each of the one or more entity types extracted from at least one of the database query and a result of executing the database query against the target database; and
respond to the user query with a first response comprising the one or more follow up queries.

18. The apparatus of claim 17,
wherein the instructions executable by the processor to cause the apparatus to retrieve the one or more parameterized user query templates further comprise instructions to retrieve a corresponding one or more database query templates,
and wherein the instructions executable by the processor to cause the apparatus to generate the one or more follow up queries further comprise instructions to populate parameters of each of the one or more database query templates with the name of each of the one or more entity types.

19. The apparatus of claim 17, wherein the database query comprises a Structured Query Language (SQL) query, wherein the instructions executable by the processor to cause the apparatus to extract the one or more entity types from the database query comprise instructions executable by the processor to cause the apparatus to extract the one or more entity types from at least one of a SQL SELECT statement of the database query and a SQL WHERE statement of the database query.

20. The apparatus of claim 19, further comprising instructions executable by the processor to cause the apparatus to extract at least a first entity name from the result of executing the database query based on extraction of a first of the one or more entity types from the SQL SELECT statement of the database query, wherein the instructions executable by the processor to cause the apparatus to extract the first entity name comprise instructions executable by the processor to cause the apparatus to extract the first entity name from the result of executing the database query.
